(19) United States
(12) Patent Application Publication
(10) Pub. No.: US 2026/0093897 A1
(43) Pub. Date: Apr. 2, 2026

(54) SYSTEM

(71) Applicant: SoftBank Group Corp., Tokyo (JP)

(72) Inventor: Kenta SHIMOMURA, Tokyo (JP)

(21) Appl. No.: 19/342,115

(22) Filed: Sep. 26, 2025

(30) Foreign Application Priority Data
Oct. 1, 2024 (JP) 2024-172612

(51) Int. Cl. G06F 40/14; G06F 3/01; G06F 8/30; G06T 11/60

(52) U.S. Cl. CPC G06F 40/14; G06F 3/011; G06F 8/30; G06T 11/60; G06F 2203/011

(57) ABSTRACT

The system according to the embodiment includes a reception unit, an analysis unit, and a generation unit. The reception unit inputs a system configuration diagram. The analysis unit analyzes requirements based on the system configuration diagram input by the reception unit. The generation unit generates a design document and code based on the requirements analyzed by the analysis unit.

### CROSS-REFERENCE TO RELATED APPLICATION

The present application claims priority to and incorporates by reference the entire contents of Japanese Patent Application No. 2024-172612 filed in Japan on Oct. 1, 2024.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, including: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem that the process of generating design documents and code from a system configuration diagram is labor-intensive, time-consuming, and inefficient.

### SUMMARY OF THE INVENTION

The system according to the embodiment includes a reception unit, an analysis unit, and a generation unit. The reception unit inputs a system configuration diagram. The analysis unit analyzes requirements based on the system configuration diagram input by the reception unit. The generation unit generates a design document and code based on the requirements analyzed by the analysis unit.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor with a sign (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) with a sign is a memory where information is temporarily stored and used as a work memory by the processor.

In the following embodiments, a storage with a sign is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) with a sign is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

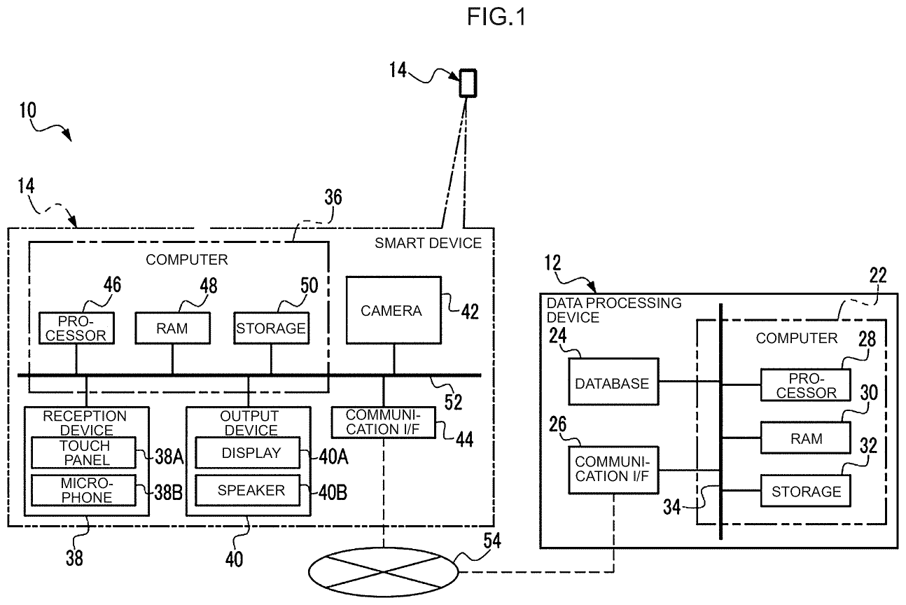

FIG. 1 shows an example configuration of a data processing system 10 according to the first embodiment.

As shown in FIG. 1, the data processing system 10 includes a data processing device 12 and a smart device 14. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 includes a computer 36, a reception device 38, an output device 40, a camera 42, and a communication I/F 44. The computer 36 includes a processor 46, RAM 48, and storage 50. The processor 46, RAM 48, and storage 50 are connected to a bus 52. The reception device 38, output device 40, and camera 42 are also connected to the bus 52.

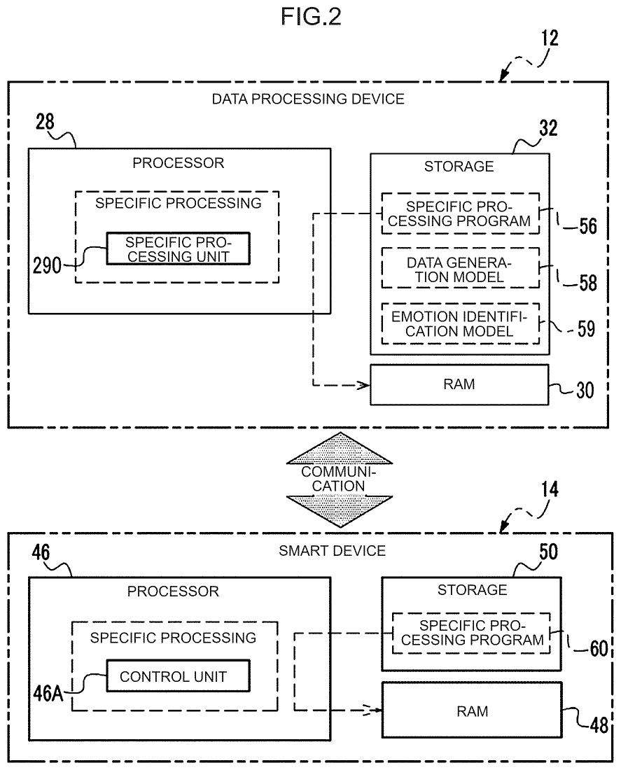

The reception device 38 includes a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 includes a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1 of Embodiment

The cloud infrastructure design and construction system according to the embodiment of the present invention is a system aimed at reducing man-hours and improving quality in the design and construction of cloud infrastructure. This system supports multimodal input and utilizes a generative AI capable of image analysis to solve the problems in conventional cloud infrastructure projects, where a large amount of man-hours was required and quality varied. First, a system configuration diagram is created and input to the generative AI as an image. Next, a dialog is conducted with the generative AI to obtain detailed information regarding the requirements. A design document format is prepared in advance, and after the dialog is completed, each design document and the code required for construction are generated from the system configuration diagram and the dialog content. As a result, work that previously required several person-months can be reduced to about one person-day. Even if the amount of conversation in the dialog is small, the system is designed to produce a more standard design document. It is also possible to modify the output design document and use it as input, allowing for flexible handling of revisions. Furthermore, the construction of the cloud infrastructure is performed by generating Terraform code. This makes it possible to reduce the number of unit tests to zero, enabling a significant reduction in man-hours. The system supports multi-cloud, reads which cloud is being used from the system configuration diagram, selects the appropriate format according to the content, and writes the design document based on the dialog content, thereby reducing man-hours. In this way, the cloud infrastructure design and construction system can significantly reduce man-hours and improve quality in the design and construction of cloud infrastructure.

The cloud infrastructure design and construction system according to the embodiment includes a reception unit, an analysis unit, and a generation unit. The reception unit inputs a system configuration diagram. The system configuration diagram may include, for example, a hardware configuration diagram, a software configuration diagram, a network configuration diagram, etc., but is not limited to these examples. The reception unit may receive the system configuration diagram as an image file, for example. The reception unit can also receive the system configuration diagram in PDF format or other digital formats. The analysis unit analyzes requirements based on the system configuration diagram input by the reception unit. Requirements analysis may include, for example, functional requirements, non-functional requirements, constraints, etc., but is not limited to these examples. The analysis unit analyzes each element of the system configuration diagram and extracts the respective requirements. The analysis unit can also identify particularly important elements in the system configuration diagram and analyze the requirements in detail based on them. The generation unit generates a design document and code based on the requirements analyzed by the analysis unit. The generation of the design document and code may include, for example, the format of the design document, the programming language of the code, etc., but is not limited to these examples. The generation unit may generate the design document based on a template for the design document, for example. The generation unit can also generate code in an appropriate programming language based on the analyzed requirements. In this way, the cloud infrastructure design and construction system can automate the process from inputting the system configuration diagram to requirements analysis and generation of the design document and code, thereby significantly reducing man-hours. Some or all of the above processing in the generation unit may be performed using a generative AI, or may be performed without using a generative AI. For example, the generation unit may input the requirements analysis results to the generative AI and have the generative AI generate the design document and code.

The reception unit inputs a system configuration diagram. The system configuration diagram may include, for example, a hardware configuration diagram, a software configuration diagram, a network configuration diagram, etc., but is not limited to these examples. The reception unit may receive the system configuration diagram as an image file, for example. The reception unit can also receive the system configuration diagram in PDF format or other digital formats. Specifically, the reception unit has a function to automatically recognize files uploaded by the user and convert them into an appropriate format. For example, in the case of an image file, OCR (Optical Character Recognition) technology is used to convert it into text data, and in the case of a PDF file, the internal structure is analyzed to extract the necessary information. Furthermore, the reception unit also provides an interface for direct input by the user, allowing the user to manually input the system configuration diagram. In this way, the reception unit flexibly accepts system configuration diagrams in various formats and enables smooth data transfer to the next analysis unit. The reception unit also has a function to check the consistency of the received system configuration diagram and notify the user of any missing or inconsistent information. This ensures the quality of the data at the initial stage and enables smooth processing by the subsequent analysis unit and generation unit.

The analysis unit analyzes requirements based on the system configuration diagram input by the reception unit. Requirements analysis may include, for example, functional requirements, non-functional requirements, constraints, etc., but is not limited to these examples. The analysis unit analyzes each element of the system configuration diagram and extracts the respective requirements. Specifically, the analysis unit analyzes the roles and interrelationships of each component in the system configuration diagram and, based on this, identifies the necessary functions and performance. For example, the analysis unit analyzes the placement of servers and the network topology to extract requirements related to the overall system performance and reliability. The analysis unit can also identify particularly important elements in the system configuration diagram and analyze the requirements in detail based on them. For example, the analysis unit analyzes the placement of databases and methods of redundancy to clarify requirements related to data consistency and availability. Furthermore, the analysis unit can perform requirements analysis using AI. Specifically, natural language processing technology is used to analyze the explanatory text of the system configuration diagram and automatically extract requirements. It is also possible to use machine learning algorithms to learn from past project data and automatically identify similar requirements. In this way, the analysis unit can efficiently and accurately analyze requirements and provide data to the next generation unit.

The generation unit generates a design document and code based on the requirements analyzed by the analysis unit. The generation of the design document and code may include, for example, the format of the design document, the programming language of the code, etc., but is not limited to these examples. The generation unit may generate the design document based on a template for the design document, for example. Specifically, the generation unit applies the requirements provided by the analysis unit to the template and automatically creates the design document for the entire system. The design document includes an overview of the system, details of each component, interrelationships, data flow, etc. The generation unit can also generate code in an appropriate programming language based on the analyzed requirements. For example, in the case of a web application, the generation unit automatically generates code such as HTML, CSS, and JavaScript (registered trademark), and generates code such as Python or Java (registered trademark) for server-side logic. Furthermore, the generation unit can use a generative AI to generate the design document and code. Specifically, the requirements analysis results are input to the generative AI, and the generative AI is made to generate the design document and code. The generative AI has learned from past project data and best practices and can generate optimal design documents and code. For example, the generative AI proposes the optimal architecture based on the requirements and creates the design document accordingly. The generative AI can also generate optimal code considering code quality and performance. In this way, the generation unit can efficiently and with high quality generate the design document and code, thereby significantly reducing the overall man-hours for the system.

A dialog unit may be provided to interact regarding detailed contents of the requirements. The dialog unit, for example, conducts dialog with the user using a chatbot. For example, the dialog unit automatically generates responses to questions from the user. The dialog unit can also use speech recognition technology to convert the user's voice into text and conduct dialog. For example, the dialog unit analyzes the user's voice input in real time and generates appropriate responses. The dialog unit can also dynamically adjust the progress of the dialog based on the user's input. For example, the dialog unit changes the next question to be presented according to the user's input. In this way, the dialog unit can obtain detailed requirements through dialog with the user and improve the accuracy of the design document and code. Some or all of the above processing in the dialog unit may be performed using AI, or may be performed without using AI. For example, the dialog unit may input the user's input to AI and have the AI control the progress of the dialog.

The analysis unit can analyze requirements based on the system configuration diagram input by the reception unit and the dialog results from the dialog unit. The analysis unit analyzes each element of the system configuration diagram and extracts the respective requirements. The analysis unit can also identify particularly important elements in the system configuration diagram and analyze the requirements in detail based on them. The analysis unit can also analyze the user's requirements in detail based on the dialog results from the dialog unit. For example, the analysis unit checks the consistency of the user's requirements obtained in the dialog unit against the system configuration diagram. The analysis unit can also combine the system configuration diagram and the dialog results to determine the priority of requirements. For example, the analysis unit dynamically adjusts the priority of requirements based on the importance of the system configuration diagram and the content of the dialog results. In this way, the analysis unit can analyze requirements by combining the system configuration diagram and dialog results, thereby improving accuracy. Some or all of the above processing in the analysis unit may be performed using AI, or may be performed without using AI. For example, the analysis unit may input the system configuration diagram and dialog results to AI and have the AI perform the requirements analysis.

The generation unit can generate the design document and code by means of a generative AI. The generation unit may generate the design document based on a template for the design document, for example. For example, the generation unit uses a generative AI to automatically generate the design document based on the analyzed requirements. The generation unit can also generate code in an appropriate programming language based on the analyzed requirements. For example, the generation unit uses a generative AI to automatically generate code based on the requirements. The generative AI may use natural language generation technology or machine learning algorithms to generate the design document and code. For example, the generative AI receives the requirements as input and generates the design document using natural language generation technology. The generative AI can also generate code based on the requirements using machine learning algorithms. In this way, the generation unit can improve the accuracy of generating the design document and code by using a generative AI. Some or all of the above processing in the generation unit may be performed using a generative AI, or may be performed without using a generative AI. For example, the generation unit may input the requirements analysis results to the generative AI and have the generative AI generate the design document and code.

The generation unit can support multi-cloud, read the type of cloud from the system configuration diagram, and select an appropriate format. The generation unit analyzes the system configuration diagram and identifies the type of cloud, for example. For example, the generation unit identifies the type of cloud based on the information of cloud services included in the system configuration diagram. The generation unit can also select an appropriate format according to the type of cloud. For example, the generation unit selects a format corresponding to cloud services such as AWS, Azure, or Google Cloud. Appropriate formats may include, for example, JSON, YAML, XML, etc., but are not limited to these examples. The generation unit analyzes the system configuration diagram, identifies the type of cloud service, and selects a format accordingly. The generation unit can also adjust the method of generating the design document and code according to the type of cloud service. For example, when generating a design document and code corresponding to AWS, the generation is performed based on AWS resource definitions and provider settings. In this way, the generation unit supports multi-cloud and can adapt to various cloud environments. Some or all of the above processing in the generation unit may be performed using a generative AI, or may be performed without using a generative AI. For example, the generation unit may input the system configuration diagram to the generative AI and have the generative AI identify the type of cloud and select the format.

The generation unit can generate Terraform code. The generation unit generates code based on Terraform resource definitions, for example. For example, the generation unit uses a generative AI to automatically generate Terraform code based on the analyzed requirements. Terraform code may include, for example, resource definitions, provider settings, etc., but is not limited to these examples. The generation unit generates Terraform resource definitions using a generative AI based on the requirements, for example. The generation unit can also generate Terraform code based on provider settings. For example, the generation unit generates Terraform code based on provider settings corresponding to cloud services such as AWS, Azure, or Google Cloud. In this way, the generation unit can automate the construction of cloud infrastructure by generating Terraform code. Some or all of the above processing in the generation unit may be performed using a generative AI, or may be performed without using a generative AI. For example, the generation unit may input the requirements analysis results to the generative AI and have the generative AI generate the Terraform code.

The reception unit can analyze the user's past project history at the time of inputting the system configuration diagram and select an optimal input method. The reception unit obtains and analyzes the user's past project history from a database, for example. For example, the reception unit preferentially proposes input methods that the user has used in the past. The reception unit can also select the most efficient input method from the user's past project history. For example, the reception unit analyzes the user's past project history and customizes the input method. The past project history may include, for example, the type of project, duration, deliverables, etc., but is not limited to these examples. In this way, the reception unit can provide an optimal input method by analyzing the user's past project history. Some or all of the above processing in the reception unit may be performed using AI, or may be performed without using AI. For example, the reception unit may input the user's past project history to AI and have the AI select the optimal input method.

The reception unit can perform filtering based on the user's current project status and areas of interest at the time of inputting the system configuration diagram. The reception unit obtains and analyzes the user's current project status from a database, for example. For example, the reception unit preferentially inputs highly relevant system configuration diagrams based on the user's current project status. The reception unit can also propose optimal system configuration diagrams based on the user's areas of interest. For example, the reception unit customizes the input content by considering the user's current project status and areas of interest. The current project status may include, for example, progress status, resource status, priority, etc., but is not limited to these examples. In this way, the reception unit can provide highly relevant system configuration diagrams based on the user's current project status and areas of interest. Some or all of the above processing in the reception unit may be performed using AI, or may be performed without using AI. For example, the reception unit may input the user's current project status and areas of interest to AI and have the AI perform the filtering.

The reception unit can prioritize inputting highly relevant configuration diagrams by considering the user's geographic location at the time of inputting the system configuration diagram. The reception unit obtains and analyzes the user's geographic location information from GPS data or IP address, for example. For example, the reception unit prioritizes inputting highly relevant system configuration diagrams based on the user's current location. The reception unit can also propose optimal system configuration diagrams by considering the user's geographic location information. For example, the reception unit customizes the input content based on the user's geographic location information. Geographic location information may include, for example, GPS data, IP address, location information services, etc., but is not limited to these examples. In this way, the reception unit can provide highly relevant system configuration diagrams by considering the user's geographic location information. Some or all of the above processing in the reception unit may be performed using AI, or may be performed without using AI. For example, the reception unit may input the user's geographic location information to AI and have the AI select highly relevant system configuration diagrams.

The reception unit can analyze the user's social media activity at the time of inputting the system configuration diagram and input relevant configuration diagrams. The reception unit obtains and analyzes the user's social media activity from a database, for example. For example, the reception unit prioritizes inputting highly relevant system configuration diagrams based on the user's social media activity. The reception unit can also propose optimal system configuration diagrams by analyzing the user's social media activity. For example, the reception unit customizes the input content based on the user's social media activity. Social media activity may include, for example, post content, number of followers, engagement, etc., but is not limited to these examples. In this way, the reception unit can provide highly relevant system configuration diagrams by analyzing the user's social media activity. Some or all of the above processing in the reception unit may be performed using AI, or may be performed without using AI. For example, the reception unit may input the user's social media activity to AI and have the AI select relevant system configuration diagrams.

The analysis unit can adjust the level of detail of analysis based on the importance of the system configuration diagram during requirements analysis. The analysis unit evaluates the importance of the system configuration diagram and adjusts the level of detail of analysis accordingly, for example. For example, the analysis unit performs detailed requirements analysis for highly important system configuration diagrams. The analysis unit can also perform concise requirements analysis for less important system configuration diagrams. The importance of the system configuration diagram may include, for example, business impact, technical risk, dependencies, etc., but is not limited to these examples. The analysis unit evaluates the business impact of the system configuration diagram and adjusts the level of detail of analysis accordingly, for example. The analysis unit can also evaluate technical risk and adjust the level of detail of analysis accordingly. In this way, the analysis unit can adjust the level of detail of analysis based on the importance of the system configuration diagram and perform efficient requirements analysis. Some or all of the above processing in the analysis unit may be performed using AI, or may be performed without using AI. For example, the analysis unit may input the importance of the system configuration diagram to AI and have the AI adjust the level of detail of analysis.

The analysis unit can apply different analysis algorithms according to the category of the system configuration diagram during requirements analysis. The analysis unit identifies the category of the system configuration diagram and applies an analysis algorithm corresponding to the category, for example. For example, the analysis unit applies a dedicated analysis algorithm to network-related system configuration diagrams. The analysis unit can also apply a dedicated analysis algorithm to database-related system configuration diagrams. The categories of system configuration diagrams may include, for example, application configuration diagrams, infrastructure configuration diagrams, security configuration diagrams, etc., but are not limited to these examples. The analysis unit applies an algorithm for analyzing application requirements to application configuration diagrams, for example. The analysis unit can also apply an algorithm for analyzing infrastructure requirements to infrastructure configuration diagrams. In this way, the analysis unit can apply analysis algorithms according to the category of the system configuration diagram and improve analysis accuracy. Some or all of the above processing in the analysis unit may be performed using AI, or may be performed without using AI. For example, the analysis unit may input the category of the system configuration diagram to AI and have the AI apply the analysis algorithm.

The analysis unit can determine the priority of analysis based on the submission timing of the system configuration diagram during requirements analysis. The analysis unit evaluates the submission timing of the system configuration diagram and determines the priority of analysis accordingly, for example. For example, the analysis unit prioritizes analysis of system configuration diagrams with a near submission date. The analysis unit can also postpone analysis of system configuration diagrams with a distant submission date. Submission timing may include, for example, submission deadline, project phase, schedule, etc., but is not limited to these examples. The analysis unit evaluates the submission deadline of the system configuration diagram and determines the priority of analysis accordingly, for example. The analysis unit can also evaluate the project phase and determine the priority of analysis accordingly. In this way, the analysis unit can determine the priority of analysis based on the submission timing of the system configuration diagram and perform efficient requirements analysis. Some or all of the above processing in the analysis unit may be performed using AI, or may be performed without using AI. For example, the analysis unit may input the submission timing of the system configuration diagram to AI and have the AI determine the priority of analysis.

The analysis unit can adjust the order of analysis based on the relevance of the system configuration diagram during requirements analysis. The analysis unit evaluates the relevance of the system configuration diagram and adjusts the order of analysis accordingly, for example. For example, the analysis unit prioritizes analysis of highly relevant system configuration diagrams. The analysis unit can also postpone analysis of less relevant system configuration diagrams. The relevance of the system configuration diagram may include, for example, functional relevance, technical relevance, business relevance, etc., but is not limited to these examples. The analysis unit evaluates the functional relevance of the system configuration diagram and adjusts the order of analysis accordingly, for example. The analysis unit can also evaluate technical relevance and adjust the order of analysis accordingly. In this way, the analysis unit can adjust the order of analysis based on the relevance of the system configuration diagram and perform efficient requirements analysis. Some or all of the above processing in the analysis unit may be performed using AI, or may be performed without using AI. For example, the analysis unit may input the relevance of the system configuration diagram to AI and have the AI adjust the order of analysis.

The generation unit can adjust the level of detail of generation based on the importance of the requirements when generating the design document and code. The generation unit evaluates the importance of the requirements and adjusts the level of detail of generation accordingly, for example. For example, the generation unit generates detailed design documents and code for highly important requirements. The generation unit can also generate concise design documents and code for less important requirements. The importance of the requirements may include, for example, business impact, technical risk, dependencies, etc., but is not limited to these examples. The generation unit evaluates the business impact of the requirements and adjusts the level of detail of generation accordingly, for example. The generation unit can also evaluate technical risk and adjust the level of detail of generation accordingly. In this way, the generation unit can adjust the level of detail of generation based on the importance of the requirements and perform efficient generation of design documents and code. Some or all of the above processing in the generation unit may be performed using a generative AI, or may be performed without using a generative AI. For example, the generation unit may input the importance of the requirements to the generative AI and have the generative AI adjust the level of detail of generation.

The generation unit can apply different generation algorithms according to the category of the requirements when generating the design document and code. The generation unit identifies the category of the requirements and applies a generation algorithm corresponding to the category, for example. For example, the generation unit applies a dedicated generation algorithm to network-related requirements. The generation unit can also apply a dedicated generation algorithm to database-related requirements. The categories of requirements may include, for example, application-related, infrastructure-related, security-related, etc., but are not limited to these examples. The generation unit applies an algorithm for generating application design documents and code to application-related requirements, for example. The generation unit can also apply an algorithm for generating infrastructure design documents and code to infrastructure-related requirements. In this way, the generation unit can apply generation algorithms according to the category of the requirements and improve generation accuracy. Some or all of the above processing in the generation unit may be performed using a generative AI, or may be performed without using a generative AI. For example, the generation unit may input the category of the requirements to the generative AI and have the generative AI apply the generation algorithm.

The generation unit can determine the priority of generation based on the submission timing of the requirements when generating the design document and code. The generation unit evaluates the submission timing of the requirements and determines the priority of generation accordingly, for example. For example, the generation unit prioritizes generation of requirements with a near submission date. The generation unit can also postpone generation of requirements with a distant submission date. Submission timing may include, for example, submission deadline, project phase, schedule, etc., but is not limited to these examples. The generation unit evaluates the submission deadline of the requirements and determines the priority of generation accordingly, for example. The generation unit can also evaluate the project phase and determine the priority of generation accordingly. In this way, the generation unit can determine the priority of generation based on the submission timing of the requirements and perform efficient generation of design documents and code. Some or all of the above processing in the generation unit may be performed using a generative AI, or may be performed without using a generative AI. For example, the generation unit may input the submission timing of the requirements to the generative AI and have the generative AI determine the priority of generation.

The generation unit can adjust the order of generation based on the relevance of the requirements when generating the design document and code. The generation unit evaluates the relevance of the requirements and adjusts the order of generation accordingly, for example. For example, the generation unit prioritizes generation of highly relevant requirements. The generation unit can also postpone generation of less relevant requirements. The relevance of the requirements may include, for example, functional relevance, technical relevance, business relevance, etc., but is not limited to these examples. The generation unit evaluates the functional relevance of the requirements and adjusts the order of generation accordingly, for example. The generation unit can also evaluate technical relevance and adjust the order of generation accordingly. In this way, the generation unit can adjust the order of generation based on the relevance of the requirements and perform efficient generation of design documents and code. Some or all of the above processing in the generation unit may be performed using a generative AI, or may be performed without using a generative AI. For example, the generation unit may input the relevance of the requirements to the generative AI and have the generative AI adjust the order of generation.

The dialog unit can select an optimal dialog method by referring to the user's past dialog history during dialog. The dialog unit obtains and analyzes the user's past dialog history from a database, for example. For example, the dialog unit selects a preferred dialog style from the user's past dialog history. The dialog unit can also preferentially use terms and phrases that the user has used in the past. The past dialog history may include, for example, dialog logs, past questions and answers, dialog results, etc., but is not limited to these examples. The dialog unit analyzes the user's past dialog history and customizes the optimal dialog method, for example. In this way, the dialog unit can provide an optimal dialog method by referring to the user's past dialog history. Some or all of the above processing in the dialog unit may be performed using AI, or may be performed without using AI. For example, the dialog unit may input the user's past dialog history to AI and have the AI select the optimal dialog method.

The dialog unit can customize the content of the dialog based on the user's current project status during dialog. The dialog unit obtains and analyzes the user's current project status from a database, for example. For example, the dialog unit provides highly relevant dialog content based on the user's current project status. The dialog unit can also propose an optimal dialog method by considering the user's current project status. The current project status may include, for example, progress status, resource status, priority, etc., but is not limited to these examples. The dialog unit customizes the dialog content based on the user's current project status, for example. In this way, the dialog unit can customize the content of the dialog based on the user's current project status and provide highly relevant dialog content. Some or all of the above processing in the dialog unit may be performed using AI, or may be performed without using AI. For example, the dialog unit may input the user's current project status to AI and have the AI customize the dialog content.

The dialog unit can select an optimal dialog method by considering the user's geographic location during dialog. The dialog unit obtains and analyzes the user's geographic location information from GPS data or IP address, for example. For example, the dialog unit provides highly relevant dialog content based on the user's current location. The dialog unit can also propose an optimal dialog method by considering the user's geographic location information. For example, the dialog unit customizes the dialog content based on the user's geographic location information. Geographic location information may include, for example, GPS data, IP address, location information services, etc., but is not limited to these examples. In this way, the dialog unit can provide highly relevant dialog content by considering the user's geographic location information. Some or all of the above processing in the dialog unit may be performed using AI, or may be performed without using AI. For example, the dialog unit may input the user's geographic location information to AI and have the AI select the optimal dialog method.

The dialog unit can analyze the user's social media activity during dialog and adjust the content of the dialog. The dialog unit obtains and analyzes the user's social media activity from a database, for example. For example, the dialog unit provides highly relevant dialog content based on the user's social media activity. The dialog unit can also propose an optimal dialog method by analyzing the user's social media activity. Social media activity may include, for example, post content, number of followers, engagement, etc., but is not limited to these examples. The dialog unit customizes the dialog content based on the user's social media activity, for example. In this way, the dialog unit can provide highly relevant dialog content by analyzing the user's social media activity. Some or all of the above processing in the dialog unit may be performed using AI, or may be performed without using AI. For example, the dialog unit may input the user's social media activity to AI and have the AI adjust the dialog content.

The system according to the embodiment is not limited to the above examples and, for example, various modifications are possible as described below.

The reception unit can analyze the user's past project history and select an optimal input method. For example, the reception unit obtains and analyzes the user's past project history from a database. The reception unit can preferentially propose input methods that the user has used in the past. The reception unit can also select the most efficient input method from the user's past project history. The past project history may include the type of project, duration, deliverables, etc., but is not limited to these examples. In this way, the reception unit can provide an optimal input method by analyzing the user's past project history. Some or all of the above processing in the reception unit may be performed using AI, or may be performed without using AI. For example, the reception unit may input the user's past project history to AI and have the AI select the optimal input method.

The analysis unit can adjust the level of detail of analysis based on the importance of the system configuration diagram during requirements analysis. For example, the analysis unit evaluates the importance of the system configuration diagram and adjusts the level of detail of analysis accordingly. The analysis unit can perform detailed requirements analysis for highly important system configuration diagrams. The analysis unit can also perform concise requirements analysis for less important system configuration diagrams. The importance of the system configuration diagram may include business impact, technical risk, dependencies, etc., but is not limited to these examples. The analysis unit can evaluate the business impact of the system configuration diagram and adjust the level of detail of analysis accordingly. The analysis unit can also evaluate technical risk and adjust the level of detail of analysis accordingly. In this way, the analysis unit can adjust the level of detail of analysis based on the importance of the system configuration diagram and perform efficient requirements analysis. Some or all of the above processing in the analysis unit may be performed using AI, or may be performed without using AI. For example, the analysis unit may input the importance of the system configuration diagram to AI and have the AI adjust the level of detail of analysis.

The generation unit can adjust the level of detail of generation based on the importance of the requirements when generating the design document and code. For example, the generation unit evaluates the importance of the requirements and adjusts the level of detail of generation accordingly. The generation unit can generate detailed design documents and code for highly important requirements. The generation unit can also generate concise design documents and code for less important requirements. The importance of the requirements may include business impact, technical risk, dependencies, etc., but is not limited to these examples. The generation unit can evaluate the business impact of the requirements and adjust the level of detail of generation accordingly. The generation unit can also evaluate technical risk and adjust the level of detail of generation accordingly. In this way, the generation unit can adjust the level of detail of generation based on the importance of the requirements and perform efficient generation of design documents and code. Some or all of the above processing in the generation unit may be performed using a generative AI, or may be performed without using a generative AI. For example, the generation unit may input the importance of the requirements to the generative AI and have the generative AI adjust the level of detail of generation.

The dialog unit can select an optimal dialog method by referring to the user's past dialog history during dialog. For example, the dialog unit obtains and analyzes the user's past dialog history from a database. The dialog unit can select a preferred dialog style from the user's past dialog history. The dialog unit can also preferentially use terms and phrases that the user has used in the past. The past dialog history may include dialog logs, past questions and answers, dialog results, etc., but is not limited to these examples. The dialog unit can analyze the user's past dialog history and customize the optimal dialog method. In this way, the dialog unit can provide an optimal dialog method by referring to the user's past dialog history. Some or all of the above processing in the dialog unit may be performed using AI, or may be performed without using AI. For example, the dialog unit may input the user's past dialog history to AI and have the AI select the optimal dialog method.

The reception unit can prioritize inputting highly relevant configuration diagrams by considering the user's geographic location at the time of inputting the system configuration diagram. For example, the reception unit obtains and analyzes the user's geographic location information from GPS data or IP address. The reception unit can prioritize inputting highly relevant system configuration diagrams based on the user's current location. The reception unit can also propose optimal system configuration diagrams by considering the user's geographic location information. For example, the reception unit customizes the input content based on the user's geographic location information. Geographic location information may include GPS data, IP address, location information services, etc., but is not limited to these examples. In this way, the reception unit can provide highly relevant system configuration diagrams by considering the user's geographic location information. Some or all of the above processing in the reception unit may be performed using AI, or may be performed without using AI. For example, the reception unit may input the user's geographic location information to AI and have the AI select highly relevant system configuration diagrams.

The dialog unit can analyze the user's social media activity during dialog and adjust the content of the dialog. For example, the dialog unit obtains and analyzes the user's social media activity from a database. The dialog unit can provide highly relevant dialog content based on the user's social media activity. The dialog unit can also propose an optimal dialog method by analyzing the user's social media activity. Social media activity may include post content, number of followers, engagement, etc., but is not limited to these examples. The dialog unit can customize the dialog content based on the user's social media activity. In this way, the dialog unit can provide highly relevant dialog content by analyzing the user's social media activity. Some or all of the above processing in the dialog unit may be performed using AI, or may be performed without using AI. For example, the dialog unit may input the user's social media activity to AI and have the AI adjust the dialog content.

The following is a brief description of the processing flow of Example 1 of the Embodiment.

Step 1: The reception unit inputs a system configuration diagram. The system configuration diagram includes a hardware configuration diagram, software configuration diagram, network configuration diagram, etc. The reception unit can receive the system configuration diagram as an image file, PDF format, or other digital formats.

Step 2: The analysis unit analyzes requirements based on the system configuration diagram input by the reception unit. Requirements analysis includes functional requirements, non-functional requirements, constraints, etc. The analysis unit analyzes each element of the system configuration diagram and extracts the respective requirements. The analysis unit also identifies particularly important elements in the system configuration diagram and analyzes the requirements in detail based on them.

Step 3: The generation unit generates a design document and code based on the requirements analyzed by the analysis unit. The generation of the design document uses design document formats and templates. The generation of code involves selecting an appropriate programming language. The generation unit can also input the requirements analysis results to a generative AI and have the generative AI generate the design document and code.

### Example 2 of Embodiment

The cloud infrastructure design and construction system according to the embodiment of the present invention is a system aimed at reducing man-hours and improving quality in the design and construction of cloud infrastructure. This system supports multimodal input and utilizes a generative AI capable of image analysis to solve the problems in conventional cloud infrastructure projects, where a large amount of man-hours was required and quality varied. First, a system configuration diagram is created and input to the generative AI as an image. Next, a dialog is conducted with the generative AI to obtain detailed information regarding the requirements. A design document format is prepared in advance, and after the dialog is completed, each design document and the code required for construction are generated from the system configuration diagram and the dialog content. As a result, work that previously required several person-months can be reduced to about one person-day. Even if the amount of conversation in the dialog is small, the system is designed to produce a more standard design document. It is also possible to modify the output design document and use it as input, allowing for flexible handling of revisions. Furthermore, the construction of the cloud infrastructure is performed by generating Terraform code. This makes it possible to reduce the number of unit tests to zero, enabling a significant reduction in man-hours. The system supports multi-cloud, reads which cloud is being used from the system configuration diagram, selects the appropriate format according to the content, and writes the design document based on the dialog content, thereby reducing man-hours. In this way, the cloud infrastructure design and construction system can significantly reduce man-hours and improve quality in the design and construction of cloud infrastructure.

The cloud infrastructure design and construction system according to the embodiment includes a reception unit, an analysis unit, and a generation unit. The reception unit inputs a system configuration diagram. The system configuration diagram may include, for example, a hardware configuration diagram, a software configuration diagram, a network configuration diagram, etc., but is not limited to these examples. The reception unit may receive the system configuration diagram as an image file, for example. The reception unit can also receive the system configuration diagram in PDF format or other digital formats. The analysis unit analyzes requirements based on the system configuration diagram input by the reception unit. Requirements analysis may include, for example, functional requirements, non-functional requirements, constraints, etc., but is not limited to these examples. The analysis unit analyzes each element of the system configuration diagram and extracts the respective requirements. The analysis unit can also identify particularly important elements in the system configuration diagram and analyze the requirements in detail based on them. The generation unit generates a design document and code based on the requirements analyzed by the analysis unit. The generation of the design document and code may include, for example, the format of the design document, the programming language of the code, etc., but is not limited to these examples. The generation unit may generate the design document based on a template for the design document, for example. The generation unit can also generate code in an appropriate programming language based on the analyzed requirements. In this way, the cloud infrastructure design and construction system can automate the process from inputting the system configuration diagram to requirements analysis and generation of the design document and code, thereby significantly reducing man-hours. Some or all of the above processing in the generation unit may be performed using a generative AI, or may be performed without using a generative AI. For example, the generation unit may input the requirements analysis results to the generative AI and have the generative AI generate the design document and code.

The reception unit inputs a system configuration diagram. The system configuration diagram may include, for example, a hardware configuration diagram, a software configuration diagram, a network configuration diagram, etc., but is not limited to these examples. The reception unit may receive the system configuration diagram as an image file, for example. The reception unit can also receive the system configuration diagram in PDF format or other digital formats. Specifically, the reception unit has a function to automatically recognize files uploaded by the user and convert them into an appropriate format. For example, in the case of an image file, OCR (Optical Character Recognition) technology is used to convert it into text data, and in the case of a PDF file, the internal structure is analyzed to extract the necessary information. Furthermore, the reception unit also provides an interface for direct input by the user, allowing the user to manually input the system configuration diagram. In this way, the reception unit flexibly accepts system configuration diagrams in various formats and enables smooth data transfer to the next analysis unit. The reception unit also has a function to check the consistency of the received system configuration diagram and notify the user of any missing or inconsistent information. This ensures the quality of the data at the initial stage and enables smooth processing by the subsequent analysis unit and generation unit.

The analysis unit analyzes requirements based on the system configuration diagram input by the reception unit. Requirements analysis may include, for example, functional requirements, non-functional requirements, constraints, etc., but is not limited to these examples. The analysis unit analyzes each element of the system configuration diagram and extracts the respective requirements. Specifically, the analysis unit analyzes the roles and interrelationships of each component in the system configuration diagram and, based on this, identifies the necessary functions and performance. For example, the analysis unit analyzes the placement of servers and the network topology to extract requirements related to the overall system performance and reliability. The analysis unit can also identify particularly important elements in the system configuration diagram and analyze the requirements in detail based on them. For example, the analysis unit analyzes the placement of databases and methods of redundancy to clarify requirements related to data consistency and availability. Furthermore, the analysis unit can perform requirements analysis using AI. Specifically, natural language processing technology is used to analyze the explanatory text of the system configuration diagram and automatically extract requirements. It is also possible to use machine learning algorithms to learn from past project data and automatically identify similar requirements. In this way, the analysis unit can efficiently and accurately analyze requirements and provide data to the next generation unit.

The generation unit generates a design document and code based on the requirements analyzed by the analysis unit. The generation of the design document and code may include, for example, the format of the design document, the programming language of the code, etc., but is not limited to these examples. The generation unit may generate the design document based on a template for the design document, for example. Specifically, the generation unit applies the requirements provided by the analysis unit to the template and automatically creates the design document for the entire system. The design document includes an overview of the system, details of each component, interrelationships, data flow, etc. The generation unit can also generate code in an appropriate programming language based on the analyzed requirements. For example, in the case of a web application, the generation unit automatically generates code such as HTML, CSS, and JavaScript, and generates code such as Python or Java for server-side logic. Furthermore, the generation unit can use a generative AI to generate the design document and code. Specifically, the requirements analysis results are input to the generative AI, and the generative AI is made to generate the design document and code. The generative AI has learned from past project data and best practices and can generate optimal design documents and code. For example, the generative AI proposes the optimal architecture based on the requirements and creates the design document accordingly. The generative AI can also generate optimal code considering code quality and performance. In this way, the generation unit can efficiently and with high quality generate the design document and code, thereby significantly reducing the overall man-hours for the system.

A dialog unit may be provided to interact regarding detailed contents of the requirements. The dialog unit, for example, conducts dialog with the user using a chatbot. For example, the dialog unit automatically generates responses to questions from the user. The dialog unit can also use speech recognition technology to convert the user's voice into text and conduct dialog. For example, the dialog unit analyzes the user's voice input in real time and generates appropriate responses. The dialog unit can also dynamically adjust the progress of the dialog based on the user's input. For example, the dialog unit changes the next question to be presented according to the user's input. In this way, the dialog unit can obtain detailed requirements through dialog with the user and improve the accuracy of the design document and code. Some or all of the above processing in the dialog unit may be performed using AI, or may be performed without using AI. For example, the dialog unit may input the user's input to AI and have the AI control the progress of the dialog.

The analysis unit can analyze requirements based on the system configuration diagram input by the reception unit and the dialog results from the dialog unit. The analysis unit analyzes each element of the system configuration diagram and extracts the respective requirements. The analysis unit can also identify particularly important elements in the system configuration diagram and analyze the requirements in detail based on them. The analysis unit can also analyze the user's requirements in detail based on the dialog results from the dialog unit. For example, the analysis unit checks the consistency of the user's requirements obtained in the dialog unit against the system configuration diagram. The analysis unit can also combine the system configuration diagram and the dialog results to determine the priority of requirements. For example, the analysis unit dynamically adjusts the priority of requirements based on the importance of the system configuration diagram and the content of the dialog results. In this way, the analysis unit can analyze requirements by combining the system configuration diagram and dialog results, thereby improving accuracy. Some or all of the above processing in the analysis unit may be performed using AI, or may be performed without using AI. For example, the analysis unit may input the system configuration diagram and dialog results to AI and have the AI perform the requirements analysis.

The generation unit can generate the design document and code by means of a generative AI. The generation unit may generate the design document based on a template for the design document, for example. For example, the generation unit uses a generative AI to automatically generate the design document based on the analyzed requirements. The generation unit can also generate code in an appropriate programming language based on the analyzed requirements. For example, the generation unit uses a generative AI to automatically generate code based on the requirements. The generative AI may use natural language generation technology or machine learning algorithms to generate the design document and code. For example, the generative AI receives the requirements as input and generates the design document using natural language generation technology. The generative AI can also generate code based on the requirements using machine learning algorithms. In this way, the generation unit can improve the accuracy of generating the design document and code by using a generative AI. Some or all of the above processing in the generation unit may be performed using a generative AI, or may be performed without using a generative AI. For example, the generation unit may input the requirements analysis results to the generative AI and have the generative AI generate the design document and code.

The generation unit can support multi-cloud, read the type of cloud from the system configuration diagram, and select an appropriate format. The generation unit analyzes the system configuration diagram and identifies the type of cloud, for example. For example, the generation unit identifies the type of cloud based on the information of cloud services included in the system configuration diagram. The generation unit can also select an appropriate format according to the type of cloud. For example, the generation unit selects a format corresponding to cloud services such as AWS, Azure, or Google Cloud. Appropriate formats may include, for example, JSON, YAML, XML, etc., but are not limited to these examples. The generation unit analyzes the system configuration diagram, identifies the type of cloud service, and selects a format accordingly. The generation unit can also adjust the method of generating the design document and code according to the type of cloud service. For example, when generating a design document and code corresponding to AWS, the generation is performed based on AWS resource definitions and provider settings. In this way, the generation unit supports multi-cloud and can adapt to various cloud environments. Some or all of the above processing in the generation unit may be performed using a generative AI, or may be performed without using a generative AI. For example, the generation unit may input the system configuration diagram to the generative AI and have the generative AI identify the type of cloud and select the format.

The generation unit can generate Terraform code. The generation unit generates code based on Terraform resource definitions, for example. For example, the generation unit uses a generative AI to automatically generate Terraform code based on the analyzed requirements. Terraform code may include, for example, resource definitions, provider settings, etc., but is not limited to these examples. The generation unit generates Terraform resource definitions using a generative AI based on the requirements, for example. The generation unit can also generate Terraform code based on provider settings. For example, the generation unit generates Terraform code based on provider settings corresponding to cloud services such as AWS, Azure, or Google Cloud. In this way, the generation unit can automate the construction of cloud infrastructure by generating Terraform code. Some or all of the above processing in the generation unit may be performed using a generative AI, or may be performed without using a generative AI. For example, the generation unit may input the requirements analysis results to the generative AI and have the generative AI generate the Terraform code.

The reception unit can estimate a user's emotion and adjust the timing of inputting the system configuration diagram based on the estimated user's emotion. For example, the reception unit captures the user's facial expression with a camera and estimates the emotion using an emotion estimation algorithm. For example, the reception unit calculates an emotion score based on changes in facial expression and adjusts the input timing. The reception unit can also record the user's voice and estimate the emotion using voice analysis technology. For example, the reception unit analyzes the tone and speed of the voice, calculates an emotion score, and adjusts the input timing. The reception unit can also collect the user's biometric data (such as heart rate and skin conductance) with sensors and estimate the emotion using an emotion estimation algorithm. For example, the reception unit calculates an emotion score based on heart rate variability and adjusts the input timing. In this way, the reception unit can adjust the input timing according to the user's emotion and reduce the user's stress. Emotion estimation is realized, for example, by using an emotion engine or a generative AI with an emotion estimation function. The generative AI may be a text generative AI (e.g., LLM) or a multimodal generative AI, but is not limited to these examples. Some or all of the above processing in the reception unit may be performed using AI, or may be performed without using AI. For example, the reception unit may input the user's image data captured by the camera to the generative AI and have the generative AI estimate the user's emotion.

The reception unit can analyze the user's past project history at the time of inputting the system configuration diagram and select an optimal input method. The reception unit obtains and analyzes the user's past project history from a database, for example. For example, the reception unit preferentially proposes input methods that the user has used in the past. The reception unit can also select the most efficient input method from the user's past project history. For example, the reception unit analyzes the user's past project history and customizes the input method. The past project history may include, for example, the type of project, duration, deliverables, etc., but is not limited to these examples. In this way, the reception unit can provide an optimal input method by analyzing the user's past project history. Some or all of the above processing in the reception unit may be performed using AI, or may be performed without using AI. For example, the reception unit may input the user's past project history to AI and have the AI select the optimal input method.

The reception unit can perform filtering based on the user's current project status and areas of interest at the time of inputting the system configuration diagram. The reception unit obtains and analyzes the user's current project status from a database, for example. For example, the reception unit preferentially inputs highly relevant system configuration diagrams based on the user's current project status. The reception unit can also propose optimal system configuration diagrams based on the user's areas of interest. For example, the reception unit customizes the input content by considering the user's current project status and areas of interest. The current project status may include, for example, progress status, resource status, priority, etc., but is not limited to these examples. In this way, the reception unit can provide highly relevant system configuration diagrams based on the user's current project status and areas of interest. Some or all of the above processing in the reception unit may be performed using AI, or may be performed without using AI. For example, the reception unit may input the user's current project status and areas of interest to AI and have the AI perform the filtering.

The reception unit can estimate a user's emotion and determine the priority of system configuration diagrams to be input based on the estimated user's emotion. For example, the reception unit captures the user's facial expression with a camera and estimates the emotion using an emotion estimation algorithm. For example, the reception unit calculates an emotion score based on changes in facial expression and determines the priority of system configuration diagrams. The reception unit can also record the user's voice and estimate the emotion using voice analysis technology. For example, the reception unit analyzes the tone and speed of the voice, calculates an emotion score, and determines the priority of system configuration diagrams. The reception unit can also collect the user's biometric data (such as heart rate and skin conductance) with sensors and estimate the emotion using an emotion estimation algorithm. For example, the reception unit calculates an emotion score based on heart rate variability and determines the priority of system configuration diagrams. In this way, the reception unit can determine the priority of system configuration diagrams according to the user's emotion and respond to the user's needs. Emotion estimation is realized, for example, by using an emotion engine or a generative AI with an emotion estimation function. The generative AI may be a text generative AI (e.g., LLM) or a multimodal generative AI, but is not limited to these examples. Some or all of the above processing in the reception unit may be performed using AI, or may be performed without using AI. For example, the reception unit may input the user's image data captured by the camera to the generative AI and have the generative AI estimate the user's emotion.

The reception unit can prioritize inputting highly relevant configuration diagrams by considering the user's geographic location at the time of inputting the system configuration diagram. The reception unit obtains and analyzes the user's geographic location information from GPS data or IP address, for example. For example, the reception unit prioritizes inputting highly relevant system configuration diagrams based on the user's current location. The reception unit can also propose optimal system configuration diagrams by considering the user's geographic location information. For example, the reception unit customizes the input content based on the user's geographic location information. Geographic location information may include, for example, GPS data, IP address, location information services, etc., but is not limited to these examples. In this way, the reception unit can provide highly relevant system configuration diagrams by considering the user's geographic location information. Some or all of the above processing in the reception unit may be performed using AI, or may be performed without using AI. For example, the reception unit may input the user's geographic location information to AI and have the AI select highly relevant system configuration diagrams.

The reception unit can analyze the user's social media activity at the time of inputting the system configuration diagram and input relevant configuration diagrams. The reception unit obtains and analyzes the user's social media activity from a database, for example. For example, the reception unit prioritizes inputting highly relevant system configuration diagrams based on the user's social media activity. The reception unit can also propose optimal system configuration diagrams by analyzing the user's social media activity. For example, the reception unit customizes the input content based on the user's social media activity. Social media activity may include, for example, post content, number of followers, engagement, etc., but is not limited to these examples. In this way, the reception unit can provide highly relevant system configuration diagrams by analyzing the user's social media activity. Some or all of the above processing in the reception unit may be performed using AI, or may be performed without using AI. For example, the reception unit may input the user's social media activity to AI and have the AI select relevant system configuration diagrams.

The analysis unit can estimate a user's emotion and adjust the method of requirements analysis based on the estimated user's emotion. For example, the analysis unit captures the user's facial expression with a camera and estimates the emotion using an emotion estimation algorithm. For example, the analysis unit calculates an emotion score based on changes in facial expression and adjusts the method of requirements analysis. The analysis unit can also record the user's voice and estimate the emotion using voice analysis technology. For example, the analysis unit analyzes the tone and speed of the voice, calculates an emotion score, and adjusts the method of requirements analysis. The analysis unit can also collect the user's biometric data (such as heart rate and skin conductance) with sensors and estimate the emotion using an emotion estimation algorithm. For example, the analysis unit calculates an emotion score based on heart rate variability and adjusts the method of requirements analysis. In this way, the analysis unit can adjust the method of requirements analysis according to the user's emotion and provide the optimal analysis method for the user. Emotion estimation is realized, for example, by using an emotion engine or a generative AI with an emotion estimation function. The generative AI may be a text generative AI (e.g., LLM) or a multimodal generative AI, but is not limited to these examples. Some or all of the above processing in the analysis unit may be performed using AI, or may be performed without using AI. For example, the analysis unit may input the user's image data captured by the camera to the generative AI and have the generative AI estimate the user's emotion.

The analysis unit can adjust the level of detail of analysis based on the importance of the system configuration diagram during requirements analysis. The analysis unit evaluates the importance of the system configuration diagram and adjusts the level of detail of analysis accordingly, for example. For example, the analysis unit performs detailed requirements analysis for highly important system configuration diagrams. The analysis unit can also perform concise requirements analysis for less important system configuration diagrams. The importance of the system configuration diagram may include, for example, business impact, technical risk, dependencies, etc., but is not limited to these examples. The analysis unit evaluates the business impact of the system configuration diagram and adjusts the level of detail of analysis accordingly, for example. The analysis unit can also evaluate technical risk and adjust the level of detail of analysis accordingly. In this way, the analysis unit can adjust the level of detail of analysis based on the importance of the system configuration diagram and perform efficient requirements analysis. Some or all of the above processing in the analysis unit may be performed using AI, or may be performed without using AI. For example, the analysis unit may input the importance of the system configuration diagram to AI and have the AI adjust the level of detail of analysis.

The analysis unit can apply different analysis algorithms according to the category of the system configuration diagram during requirements analysis. The analysis unit identifies the category of the system configuration diagram and applies an analysis algorithm corresponding to the category, for example. For example, the analysis unit applies a dedicated analysis algorithm to network-related system configuration diagrams. The analysis unit can also apply a dedicated analysis algorithm to database-related system configuration diagrams. The categories of system configuration diagrams may include, for example, application configuration diagrams, infrastructure configuration diagrams, security configuration diagrams, etc., but are not limited to these examples. The analysis unit applies an algorithm for analyzing application requirements to application configuration diagrams, for example. The analysis unit can also apply an algorithm for analyzing infrastructure requirements to infrastructure configuration diagrams. In this way, the analysis unit can apply analysis algorithms according to the category of the system configuration diagram and improve analysis accuracy. Some or all of the above processing in the analysis unit may be performed using AI, or may be performed without using AI. For example, the analysis unit may input the category of the system configuration diagram to AI and have the AI apply the analysis algorithm.

The analysis unit can estimate a user's emotion and determine the priority of requirements analysis based on the estimated user's emotion. For example, the analysis unit captures the user's facial expression with a camera and estimates the emotion using an emotion estimation algorithm. For example, the analysis unit calculates an emotion score based on changes in facial expression and determines the priority of requirements analysis. The analysis unit can also record the user's voice and estimate the emotion using voice analysis technology. For example, the analysis unit analyzes the tone and speed of the voice, calculates an emotion score, and determines the priority of requirements analysis. The analysis unit can also collect the user's biometric data (such as heart rate and skin conductance) with sensors and estimate the emotion using an emotion estimation algorithm. For example, the analysis unit calculates an emotion score based on heart rate variability and determines the priority of requirements analysis. In this way, the analysis unit can determine the priority of requirements analysis according to the user's emotion and respond to the user's needs. Emotion estimation is realized, for example, by using an emotion engine or a generative AI with an emotion estimation function. The generative AI may be a text generative AI (e.g., LLM) or a multimodal generative AI, but is not limited to these examples. Some or all of the above processing in the analysis unit may be performed using AI, or may be performed without using AI. For example, the analysis unit may input the user's image data captured by the camera to the generative AI and have the generative AI estimate the user's emotion.

The analysis unit can determine the priority of analysis based on the submission timing of the system configuration diagram during requirements analysis. The analysis unit evaluates the submission timing of the system configuration diagram and determines the priority of analysis accordingly, for example. For example, the analysis unit prioritizes analysis of system configuration diagrams with a near submission date. The analysis unit can also postpone analysis of system configuration diagrams with a distant submission date. Submission timing may include, for example, submission deadline, project phase, schedule, etc., but is not limited to these examples. The analysis unit evaluates the submission deadline of the system configuration diagram and determines the priority of analysis accordingly, for example. The analysis unit can also evaluate the project phase and determine the priority of analysis accordingly. In this way, the analysis unit can determine the priority of analysis based on the submission timing of the system configuration diagram and perform efficient requirements analysis. Some or all of the above processing in the analysis unit may be performed using AI, or may be performed without using AI. For example, the analysis unit may input the submission timing of the system configuration diagram to AI and have the AI determine the priority of analysis.

The analysis unit can adjust the order of analysis based on the relevance of the system configuration diagram during requirements analysis. The analysis unit evaluates the relevance of the system configuration diagram and adjusts the order of analysis accordingly, for example. For example, the analysis unit prioritizes analysis of highly relevant system configuration diagrams. The analysis unit can also postpone analysis of less relevant system configuration diagrams. The relevance of the system configuration diagram may include, for example, functional relevance, technical relevance, business relevance, etc., but is not limited to these examples. The analysis unit evaluates the functional relevance of the system configuration diagram and adjusts the order of analysis accordingly, for example. The analysis unit can also evaluate technical relevance and adjust the order of analysis accordingly. In this way, the analysis unit can adjust the order of analysis based on the relevance of the system configuration diagram and perform efficient requirements analysis. Some or all of the above processing in the analysis unit may be performed using AI, or may be performed without using AI. For example, the analysis unit may input the relevance of the system configuration diagram to AI and have the AI adjust the order of analysis.

The generation unit can estimate a user's emotion and adjust the method of generating the design document and code based on the estimated user's emotion. For example, the generation unit captures the user's facial expression with a camera and estimates the emotion using an emotion estimation algorithm. For example, the generation unit calculates an emotion score based on changes in facial expression and adjusts the method of generating the design document and code. The generation unit can also record the user's voice and estimate the emotion using voice analysis technology. For example, the generation unit analyzes the tone and speed of the voice, calculates an emotion score, and adjusts the method of generating the design document and code. The generation unit can also collect the user's biometric data (such as heart rate and skin conductance) with sensors and estimate the emotion using an emotion estimation algorithm. For example, the generation unit calculates an emotion score based on heart rate variability and adjusts the method of generating the design document and code. In this way, the generation unit can adjust the method of generating the design document and code according to the user's emotion and provide the optimal generation method for the user. Emotion estimation is realized, for example, by using an emotion engine or a generative AI with an emotion estimation function. The generative AI may be a text generative AI (e.g., LLM) or a multimodal generative AI, but is not limited to these examples. Some or all of the above processing in the generation unit may be performed using AI, or may be performed without using AI. For example, the generation unit may input the user's image data captured by the camera to the generative AI and have the generative AI estimate the user's emotion.

The generation unit can adjust the level of detail of generation based on the importance of the requirements when generating the design document and code. The generation unit evaluates the importance of the requirements and adjusts the level of detail of generation accordingly, for example. For example, the generation unit generates detailed design documents and code for highly important requirements. The generation unit can also generate concise design documents and code for less important requirements. The importance of the requirements may include, for example, business impact, technical risk, dependencies, etc., but is not limited to these examples. The generation unit evaluates the business impact of the requirements and adjusts the level of detail of generation accordingly, for example. The generation unit can also evaluate technical risk and adjust the level of detail of generation accordingly. In this way, the generation unit can adjust the level of detail of generation based on the importance of the requirements and perform efficient generation of design documents and code. Some or all of the above processing in the generation unit may be performed using a generative AI, or may be performed without using a generative AI. For example, the generation unit may input the importance of the requirements to the generative AI and have the generative AI adjust the level of detail of generation.

The generation unit can apply different generation algorithms according to the category of the requirements when generating the design document and code. The generation unit identifies the category of the requirements and applies a generation algorithm corresponding to the category, for example. For example, the generation unit applies a dedicated generation algorithm to network-related requirements. The generation unit can also apply a dedicated generation algorithm to database-related requirements. The categories of requirements may include, for example, application-related, infrastructure-related, security-related, etc., but are not limited to these examples. The generation unit applies an algorithm for generating application design documents and code to application-related requirements, for example. The generation unit can also apply an algorithm for generating infrastructure design documents and code to infrastructure-related requirements. In this way, the generation unit can apply generation algorithms according to the category of the requirements and improve generation accuracy. Some or all of the above processing in the generation unit may be performed using a generative AI, or may be performed without using a generative AI. For example, the generation unit may input the category of the requirements to the generative AI and have the generative AI apply the generation algorithm.

The generation unit can estimate a user's emotion and adjust the order of generating the design document and code based on the estimated user's emotion. For example, the generation unit captures the user's facial expression with a camera and estimates the emotion using an emotion estimation algorithm. For example, the generation unit calculates an emotion score based on changes in facial expression and adjusts the order of generating the design document and code. The generation unit can also record the user's voice and estimate the emotion using voice analysis technology. For example, the generation unit analyzes the tone and speed of the voice, calculates an emotion score, and adjusts the order of generating the design document and code. The generation unit can also collect the user's biometric data (such as heart rate and skin conductance) with sensors and estimate the emotion using an emotion estimation algorithm. For example, the generation unit calculates an emotion score based on heart rate variability and adjusts the order of generating the design document and code. In this way, the generation unit can adjust the order of generating the design document and code according to the user's emotion and respond to the user's needs. Emotion estimation is realized, for example, by using an emotion engine or a generative AI with an emotion estimation function. The generative AI may be a text generative AI (e.g., LLM) or a multimodal generative AI, but is not limited to these examples. Some or all of the above processing in the generation unit may be performed using a generative AI, or may be performed without using a generative AI. For example, the generation unit may input the user's image data captured by the camera to the generative AI and have the generative AI estimate the user's emotion.

The generation unit can determine the priority of generation based on the submission timing of the requirements when generating the design document and code. The generation unit evaluates the submission timing of the requirements and determines the priority of generation accordingly, for example. For example, the generation unit prioritizes generation of requirements with a near submission date. The generation unit can also postpone generation of requirements with a distant submission date. Submission timing may include, for example, submission deadline, project phase, schedule, etc., but is not limited to these examples. The generation unit evaluates the submission deadline of the requirements and determines the priority of generation accordingly, for example. The generation unit can also evaluate the project phase and determine the priority of generation accordingly. In this way, the generation unit can determine the priority of generation based on the submission timing of the requirements and perform efficient generation of design documents and code. Some or all of the above processing in the generation unit may be performed using a generative AI, or may be performed without using a generative AI. For example, the generation unit may input the submission timing of the requirements to the generative AI and have the generative AI determine the priority of generation.

The generation unit can adjust the order of generation based on the relevance of the requirements when generating the design document and code. The generation unit evaluates the relevance of the requirements and adjusts the order of generation accordingly, for example. For example, the generation unit prioritizes generation of highly relevant requirements. The generation unit can also postpone generation of less relevant requirements. The relevance of the requirements may include, for example, functional relevance, technical relevance, business relevance, etc., but is not limited to these examples. The generation unit evaluates the functional relevance of the requirements and adjusts the order of generation accordingly, for example. The generation unit can also evaluate technical relevance and adjust the order of generation accordingly. In this way, the generation unit can adjust the order of generation based on the relevance of the requirements and perform efficient generation of design documents and code. Some or all of the above processing in the generation unit may be performed using a generative AI, or may be performed without using a generative AI. For example, the generation unit may input the relevance of the requirements to the generative AI and have the generative AI adjust the order of generation.

The dialog unit can estimate a user's emotion and adjust the progress of the dialog based on the estimated user's emotion. For example, the dialog unit captures the user's facial expression with a camera and estimates the emotion using an emotion estimation algorithm. For example, the dialog unit calculates an emotion score based on changes in facial expression and adjusts the progress of the dialog. The dialog unit can also record the user's voice and estimate the emotion using voice analysis technology. For example, the dialog unit analyzes the tone and speed of the voice, calculates an emotion score, and adjusts the progress of the dialog. The dialog unit can also collect the user's biometric data (such as heart rate and skin conductance) with sensors and estimate the emotion using an emotion estimation algorithm. For example, the dialog unit calculates an emotion score based on heart rate variability and adjusts the progress of the dialog. In this way, the dialog unit can adjust the progress of the dialog according to the user's emotion and provide the optimal dialog method for the user. Emotion estimation is realized, for example, by using an emotion engine or a generative AI with an emotion estimation function. The generative AI may be a text generative AI (e.g., LLM) or a multimodal generative AI, but is not limited to these examples. Some or all of the above processing in the dialog unit may be performed using AI, or may be performed without using AI. For example, the dialog unit may input the user's image data captured by the camera to the generative AI and have the generative AI estimate the user's emotion.

The dialog unit can select an optimal dialog method by referring to the user's past dialog history during dialog. The dialog unit obtains and analyzes the user's past dialog history from a database, for example. For example, the dialog unit selects a preferred dialog style from the user's past dialog history. The dialog unit can also preferentially use terms and phrases that the user has used in the past. The past dialog history may include, for example, dialog logs, past questions and answers, dialog results, etc., but is not limited to these examples. The dialog unit analyzes the user's past dialog history and customizes the optimal dialog method, for example. In this way, the dialog unit can provide an optimal dialog method by referring to the user's past dialog history. Some or all of the above processing in the dialog unit may be performed using AI, or may be performed without using AI. For example, the dialog unit may input the user's past dialog history to AI and have the AI select the optimal dialog method.

The dialog unit can customize the content of the dialog based on the user's current project status during dialog. The dialog unit obtains and analyzes the user's current project status from a database, for example. For example, the dialog unit provides highly relevant dialog content based on the user's current project status. The dialog unit can also propose an optimal dialog method by considering the user's current project status. The current project status may include, for example, progress status, resource status, priority, etc., but is not limited to these examples. The dialog unit customizes the dialog content based on the user's current project status, for example. In this way, the dialog unit can customize the content of the dialog based on the user's current project status and provide highly relevant dialog content. Some or all of the above processing in the dialog unit may be performed using AI, or may be performed without using AI. For example, the dialog unit may input the user's current project status to AI and have the AI customize the dialog content.

The dialog unit can estimate a user's emotion and determine the priority of dialog based on the estimated user's emotion. For example, the dialog unit captures the user's facial expression with a camera and estimates the emotion using an emotion estimation algorithm. For example, the dialog unit calculates an emotion score based on changes in facial expression and determines the priority of dialog. The dialog unit can also record the user's voice and estimate the emotion using voice analysis technology. For example, the dialog unit analyzes the tone and speed of the voice, calculates an emotion score, and determines the priority of dialog. The dialog unit can also collect the user's biometric data (such as heart rate and skin conductance) with sensors and estimate the emotion using an emotion estimation algorithm. For example, the dialog unit calculates an emotion score based on heart rate variability and determines the priority of dialog. In this way, the dialog unit can determine the priority of dialog according to the user's emotion and respond to the user's needs. Emotion estimation is realized, for example, by using an emotion engine or a generative AI with an emotion estimation function. The generative AI may be a text generative AI (e.g., LLM) or a multimodal generative AI, but is not limited to these examples. Some or all of the above processing in the dialog unit may be performed using AI, or may be performed without using AI. For example, the dialog unit may input the user's image data captured by the camera to the generative AI and have the generative AI estimate the user's emotion.

The dialog unit can select an optimal dialog method by considering the user's geographic location during dialog. The dialog unit obtains and analyzes the user's geographic location information from GPS data or IP address, for example. For example, the dialog unit provides highly relevant dialog content based on the user's current location. The dialog unit can also propose an optimal dialog method by considering the user's geographic location information. For example, the dialog unit customizes the dialog content based on the user's geographic location information. Geographic location information may include, for example, GPS data, IP address, location information services, etc., but is not limited to these examples. In this way, the dialog unit can provide highly relevant dialog content by considering the user's geographic location information. Some or all of the above processing in the dialog unit may be performed using AI, or may be performed without using AI. For example, the dialog unit may input the user's geographic location information to AI and have the AI select the optimal dialog method.

The dialog unit can analyze the user's social media activity during dialog and adjust the content of the dialog. The dialog unit obtains and analyzes the user's social media activity from a database, for example. For example, the dialog unit provides highly relevant dialog content based on the user's social media activity. The dialog unit can also propose an optimal dialog method by analyzing the user's social media activity. Social media activity may include, for example, post content, number of followers, engagement, etc., but is not limited to these examples. The dialog unit customizes the dialog content based on the user's social media activity, for example. In this way, the dialog unit can provide highly relevant dialog content by analyzing the user's social media activity. Some or all of the above processing in the dialog unit may be performed using AI, or may be performed without using AI. For example, the dialog unit may input the user's social media activity to AI and have the AI adjust the dialog content.

The system according to the embodiment is not limited to the above examples and, for example, various modifications are possible as described below.

The reception unit can analyze the user's past project history and select an optimal input method. For example, the reception unit obtains and analyzes the user's past project history from a database. The reception unit can preferentially propose input methods that the user has used in the past. The reception unit can also select the most efficient input method from the user's past project history. The past project history may include the type of project, duration, deliverables, etc., but is not limited to these examples. In this way, the reception unit can provide an optimal input method by analyzing the user's past project history. Some or all of the above processing in the reception unit may be performed using AI, or may be performed without using AI. For example, the reception unit may input the user's past project history to AI and have the AI select the optimal input method.

The analysis unit can adjust the level of detail of analysis based on the importance of the system configuration diagram during requirements analysis. For example, the analysis unit evaluates the importance of the system configuration diagram and adjusts the level of detail of analysis accordingly. The analysis unit can perform detailed requirements analysis for highly important system configuration diagrams. The analysis unit can also perform concise requirements analysis for less important system configuration diagrams. The importance of the system configuration diagram may include business impact, technical risk, dependencies, etc., but is not limited to these examples. The analysis unit can evaluate the business impact of the system configuration diagram and adjust the level of detail of analysis accordingly. The analysis unit can also evaluate technical risk and adjust the level of detail of analysis accordingly. In this way, the analysis unit can adjust the level of detail of analysis based on the importance of the system configuration diagram and perform efficient requirements analysis. Some or all of the above processing in the analysis unit may be performed using AI, or may be performed without using AI. For example, the analysis unit may input the importance of the system configuration diagram to AI and have the AI adjust the level of detail of analysis.

The generation unit can adjust the level of detail of generation based on the importance of the requirements when generating the design document and code. For example, the generation unit evaluates the importance of the requirements and adjusts the level of detail of generation accordingly. The generation unit can generate detailed design documents and code for highly important requirements. The generation unit can also generate concise design documents and code for less important requirements. The importance of the requirements may include business impact, technical risk, dependencies, etc., but is not limited to these examples. The generation unit can evaluate the business impact of the requirements and adjust the level of detail of generation accordingly. The generation unit can also evaluate technical risk and adjust the level of detail of generation accordingly. In this way, the generation unit can adjust the level of detail of generation based on the importance of the requirements and perform efficient generation of design documents and code. Some or all of the above processing in the generation unit may be performed using a generative AI, or may be performed without using a generative AI. For example, the generation unit may input the importance of the requirements to the generative AI and have the generative AI adjust the level of detail of generation.

The dialog unit can select an optimal dialog method by referring to the user's past dialog history during dialog. For example, the dialog unit obtains and analyzes the user's past dialog history from a database. The dialog unit can select a preferred dialog style from the user's past dialog history. The dialog unit can also preferentially use terms and phrases that the user has used in the past. The past dialog history may include dialog logs, past questions and answers, dialog results, etc., but is not limited to these examples. The dialog unit can analyze the user's past dialog history and customize the optimal dialog method. In this way, the dialog unit can provide an optimal dialog method by referring to the user's past dialog history. Some or all of the above processing in the dialog unit may be performed using AI, or may be performed without using AI. For example, the dialog unit may input the user's past dialog history to AI and have the AI select the optimal dialog method.

The reception unit can estimate a user's emotion and adjust the timing of inputting the system configuration diagram based on the estimated user's emotion. For example, the reception unit captures the user's facial expression with a camera and estimates the emotion using an emotion estimation algorithm. The reception unit can calculate an emotion score based on changes in facial expression and adjust the input timing. The reception unit can also record the user's voice and estimate the emotion using voice analysis technology. The reception unit can analyze the tone and speed of the voice, calculate an emotion score, and adjust the input timing. The reception unit can also collect the user's biometric data (such as heart rate and skin conductance) with sensors and estimate the emotion using an emotion estimation algorithm. The reception unit can calculate an emotion score based on heart rate variability and adjust the input timing. In this way, the reception unit can adjust the input timing according to the user's emotion and reduce the user's stress. Emotion estimation is realized by using an emotion engine or a generative AI with an emotion estimation function. The generative AI may be a text generative AI (e.g., LLM) or a multimodal generative AI, but is not limited to these examples. Some or all of the above processing in the reception unit may be performed using AI, or may be performed without using AI. For example, the reception unit may input the user's image data captured by the camera to the generative AI and have the generative AI estimate the user's emotion.

The analysis unit can estimate a user's emotion and adjust the method of requirements analysis based on the estimated user's emotion. For example, the analysis unit captures the user's facial expression with a camera and estimates the emotion using an emotion estimation algorithm. The analysis unit can calculate an emotion score based on changes in facial expression and adjust the method of requirements analysis. The analysis unit can also record the user's voice and estimate the emotion using voice analysis technology. The analysis unit can analyze the tone and speed of the voice, calculate an emotion score, and adjust the method of requirements analysis. The analysis unit can also collect the user's biometric data (such as heart rate and skin conductance) with sensors and estimate the emotion using an emotion estimation algorithm. The analysis unit can calculate an emotion score based on heart rate variability and adjust the method of requirements analysis. In this way, the analysis unit can adjust the method of requirements analysis according to the user's emotion and provide the optimal analysis method for the user. Emotion estimation is realized by using an emotion engine or a generative AI with an emotion estimation function. The generative AI may be a text generative AI (e.g., LLM) or a multimodal generative AI, but is not limited to these examples. Some or all of the above processing in the analysis unit may be performed using AI, or may be performed without using AI. For example, the analysis unit may input the user's image data captured by the camera to the generative AI and have the generative AI estimate the user's emotion.

The generation unit can estimate a user's emotion and adjust the method of generating the design document and code based on the estimated user's emotion. For example, the generation unit captures the user's facial expression with a camera and estimates the emotion using an emotion estimation algorithm. The generation unit can calculate an emotion score based on changes in facial expression and adjust the method of generating the design document and code. The generation unit can also record the user's voice and estimate the emotion using voice analysis technology. The generation unit can analyze the tone and speed of the voice, calculate an emotion score, and adjust the method of generating the design document and code. The generation unit can also collect the user's biometric data (such as heart rate and skin conductance) with sensors and estimate the emotion using an emotion estimation algorithm. The generation unit can calculate an emotion score based on heart rate variability and adjust the method of generating the design document and code. In this way, the generation unit can adjust the method of generating the design document and code according to the user's emotion and provide the optimal generation method for the user. Emotion estimation is realized by using an emotion engine or a generative AI with an emotion estimation function. The generative AI may be a text generative AI (e.g., LLM) or a multimodal generative AI, but is not limited to these examples. Some or all of the above processing in the generation unit may be performed using AI, or may be performed without using AI. For example, the generation unit may input the user's image data captured by the camera to the generative AI and have the generative AI estimate the user's emotion.

The dialog unit can estimate a user's emotion and adjust the progress of the dialog based on the estimated user's emotion. For example, the dialog unit captures the user's facial expression with a camera and estimates the emotion using an emotion estimation algorithm. The dialog unit can calculate an emotion score based on changes in facial expression and adjust the progress of the dialog. The dialog unit can also record the user's voice and estimate the emotion using voice analysis technology. The dialog unit can analyze the tone and speed of the voice, calculate an emotion score, and adjust the progress of the dialog. The dialog unit can also collect the user's biometric data (such as heart rate and skin conductance) with sensors and estimate the emotion using an emotion estimation algorithm. The dialog unit can calculate an emotion score based on heart rate variability and adjust the progress of the dialog. In this way, the dialog unit can adjust the progress of the dialog according to the user's emotion and provide the optimal dialog method for the user. Emotion estimation is realized by using an emotion engine or a generative AI with an emotion estimation function. The generative AI may be a text generative AI (e.g., LLM) or a multimodal generative AI, but is not limited to these examples. Some or all of the above processing in the dialog unit may be performed using AI, or may be performed without using AI. For example, the dialog unit may input the user's image data captured by the camera to the generative AI and have the generative AI estimate the user's emotion.

The reception unit can prioritize inputting highly relevant configuration diagrams by considering the user's geographic location at the time of inputting the system configuration diagram. For example, the reception unit obtains and analyzes the user's geographic location information from GPS data or IP address. The reception unit can prioritize inputting highly relevant system configuration diagrams based on the user's current location. The reception unit can also propose optimal system configuration diagrams by considering the user's geographic location information. For example, the reception unit customizes the input content based on the user's geographic location information. Geographic location information may include GPS data, IP address, location information services, etc., but is not limited to these examples. In this way, the reception unit can provide highly relevant system configuration diagrams by considering the user's geographic location information. Some or all of the above processing in the reception unit may be performed using AI, or may be performed without using AI. For example, the reception unit may input the user's geographic location information to AI and have the AI select highly relevant system configuration diagrams.

The dialog unit can analyze the user's social media activity during dialog and adjust the content of the dialog. For example, the dialog unit obtains and analyzes the user's social media activity from a database. The dialog unit can provide highly relevant dialog content based on the user's social media activity. The dialog unit can also propose an optimal dialog method by analyzing the user's social media activity. Social media activity may include post content, number of followers, engagement, etc., but is not limited to these examples. The dialog unit can customize the dialog content based on the user's social media activity. In this way, the dialog unit can provide highly relevant dialog content by analyzing the user's social media activity. Some or all of the above processing in the dialog unit may be performed using AI, or may be performed without using AI. For example, the dialog unit may input the user's social media activity to AI and have the AI adjust the dialog content.

The following is a brief description of the processing flow of Example 2 of the Embodiment.

Step 1: The reception unit inputs a system configuration diagram. The system configuration diagram includes a hardware configuration diagram, software configuration diagram, network configuration diagram, etc. The reception unit can receive the system configuration diagram as an image file, PDF format, or other digital formats.

Step 2: The analysis unit analyzes requirements based on the system configuration diagram input by the reception unit. Requirements analysis includes functional requirements, non-functional requirements, constraints, etc. The analysis unit analyzes each element of the system configuration diagram and extracts the respective requirements. The analysis unit also identifies particularly important elements in the system configuration diagram and analyzes the requirements in detail based on them.

Step 3: The generation unit generates a design document and code based on the requirements analyzed by the analysis unit. The generation of the design document uses design document formats and templates. The generation of code involves selecting an appropriate programming language. The generation unit can also input the requirements analysis results to a generative AI and have the generative AI generate the design document and code.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

For example, the reception unit can input a system configuration diagram via the reception device 38 of the smart device 14 or the communication I/F 26 of the data processing device 12. For example, the analysis unit is implemented by the specific processing unit 290 of the data processing device 12 and analyzes the requirements of the system configuration diagram. For example, the generation unit can generate the design document and code by the specific processing unit 290 of the data processing device 12. The correspondence between each unit and the device or control unit is not limited to the above examples and various modifications are possible.

### Second Embodiment

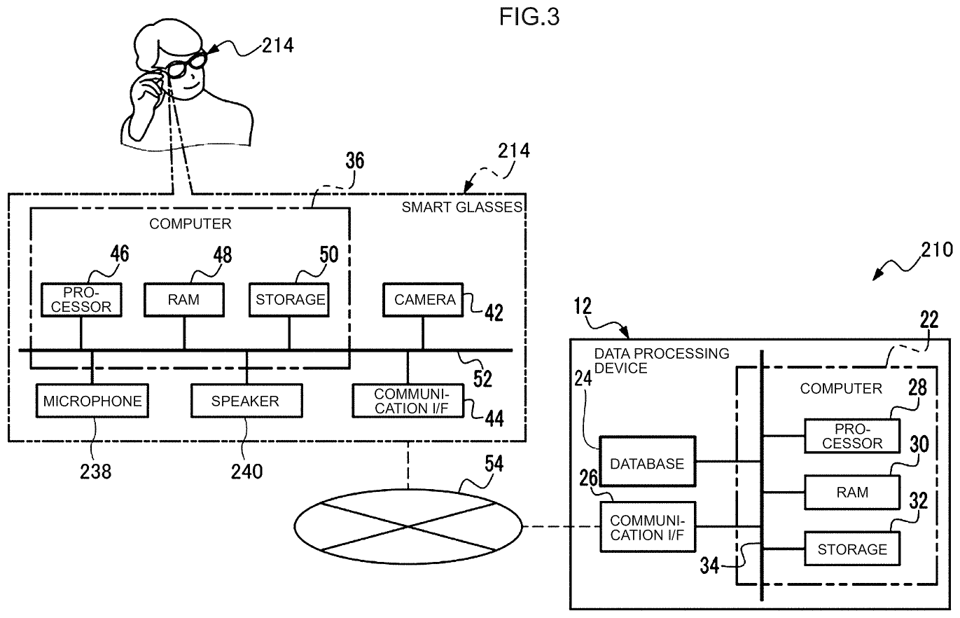

FIG. 3 shows an example configuration of a data processing system 210 according to the second embodiment.

As shown in FIG. 3, the data processing system 210 includes a data processing device 12 and smart glasses 214. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 includes a computer 36, a microphone 238, a speaker 240, a camera 42, and a communication I/F 44. The computer 36 includes a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

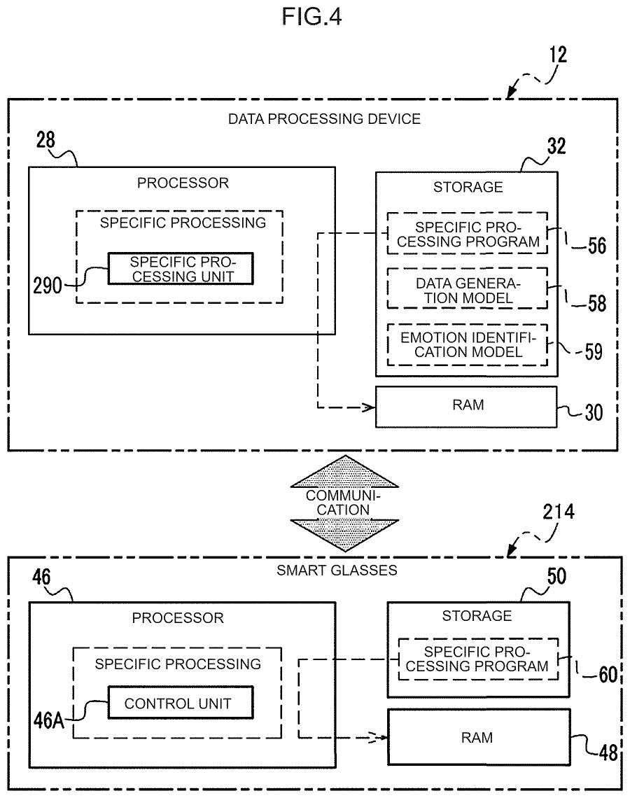

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

For example, the reception unit can input a system configuration diagram via the microphone 238 of the smart glasses 214 or the communication I/F 26 of the data processing device 12. For example, the analysis unit is implemented by the specific processing unit 290 of the data processing device 12 and analyzes the requirements of the system configuration diagram. For example, the generation unit can generate the design document and code by the specific processing unit 290 of the data processing device 12. The correspondence between each unit and the device or control unit is not limited to the above examples and various modifications are possible.

### Third Embodiment

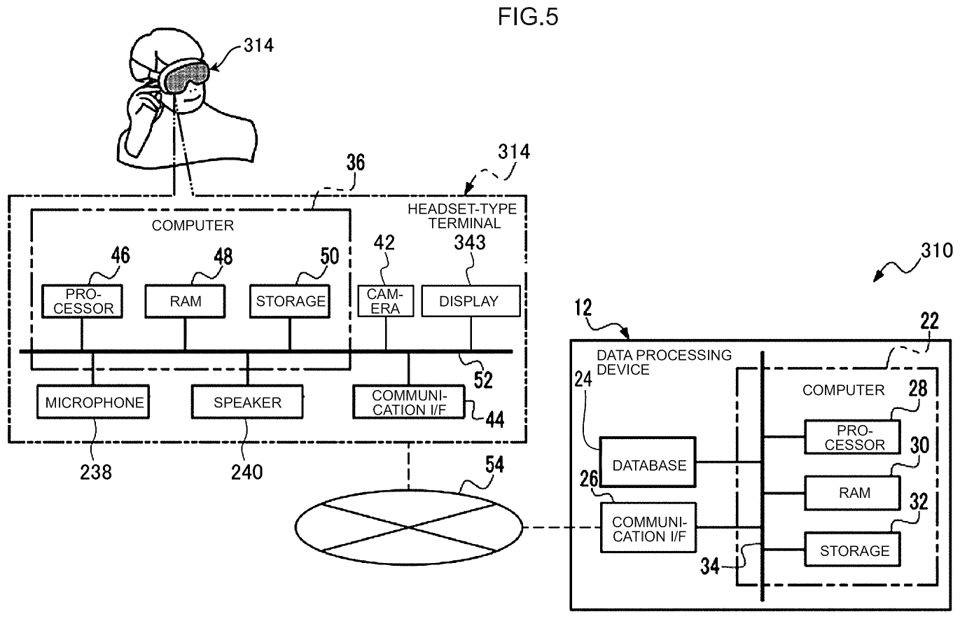

FIG. 5 shows an example configuration of a data processing system 310 according to the third embodiment.

As shown in FIG. 5, the data processing system 310 includes a data processing device 12 and a headset-type terminal 314. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 includes a computer 36, a microphone 238, a speaker 240, a camera 42, a communication I/F 44, and a display 343. The computer 36 includes a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

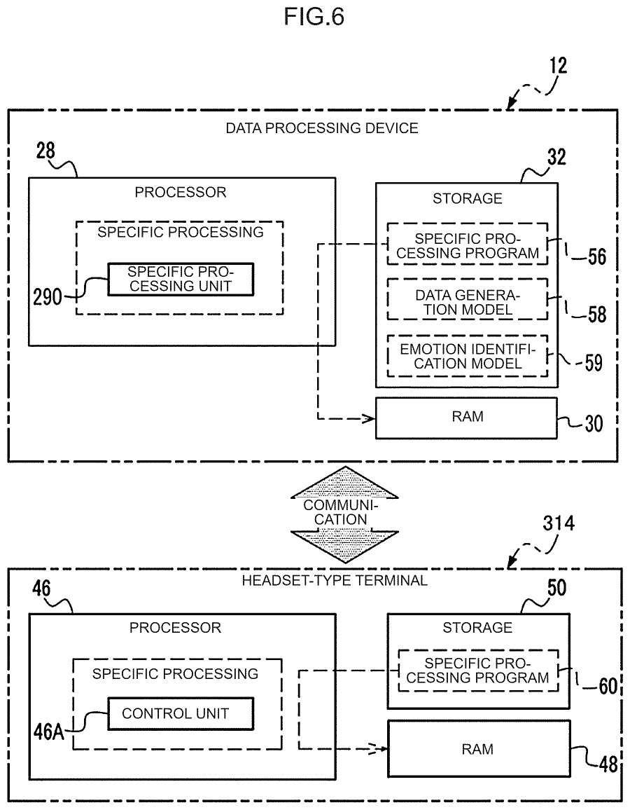

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

For example, the reception unit can input a system configuration diagram via the microphone 238 of the headset-type terminal 314 or the communication I/F 26 of the data processing device 12. For example, the analysis unit is implemented by the specific processing unit 290 of the data processing device 12 and analyzes the requirements of the system configuration diagram. For example, the generation unit can generate the design document and code by the specific processing unit 290 of the data processing device 12. The correspondence between each unit and the device or control unit is not limited to the above examples and various modifications are possible.

### Fourth Embodiment

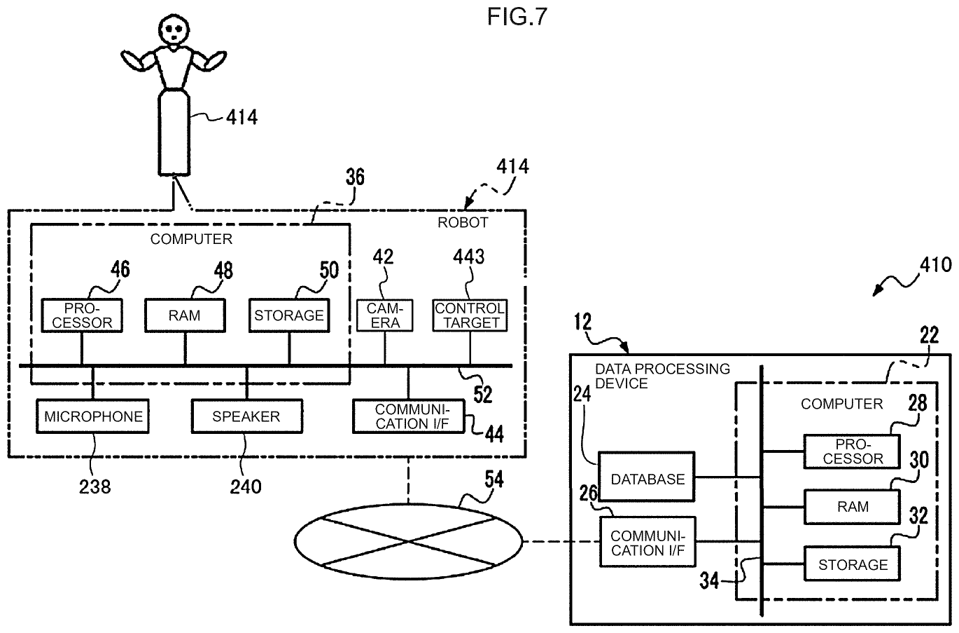

FIG. 7 shows an example configuration of a data processing system 410 according to the fourth embodiment.

As shown in FIG. 7, the data processing system 410 includes a data processing device 12 and a robot 414. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 includes a computer 36, a microphone 238, a speaker 240, a camera 42, a communication I/F 44, and a control target 443. The computer 36 includes a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

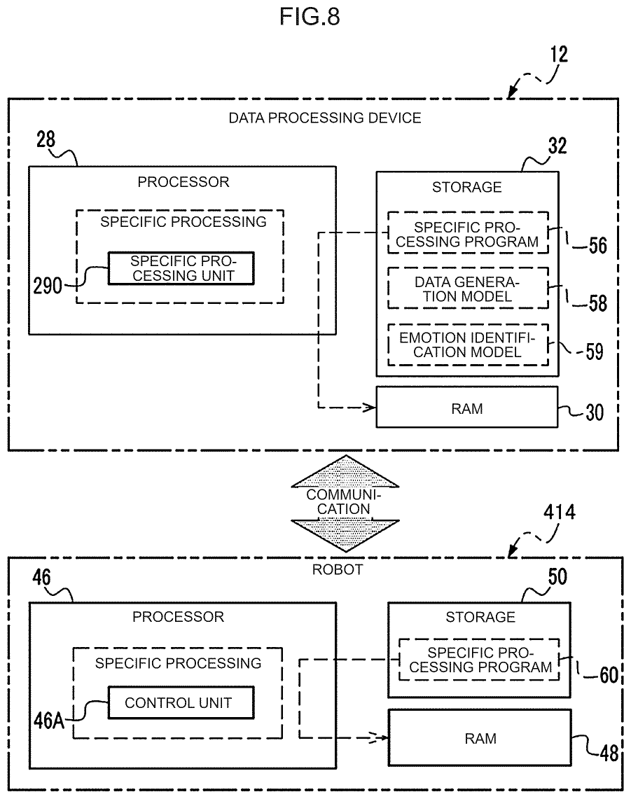

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

For example, the reception unit can input a system configuration diagram via the microphone 238 of the robot 414 or the communication I/F 26 of the data processing device 12. For example, the analysis unit is implemented by the specific processing unit 290 of the data processing device 12 and analyzes the requirements of the system configuration diagram. For example, the generation unit can generate the design document and code by the specific processing unit 290 of the data processing device 12. The correspondence between each unit and the device or control unit is not limited to the above examples and various modifications are possible.

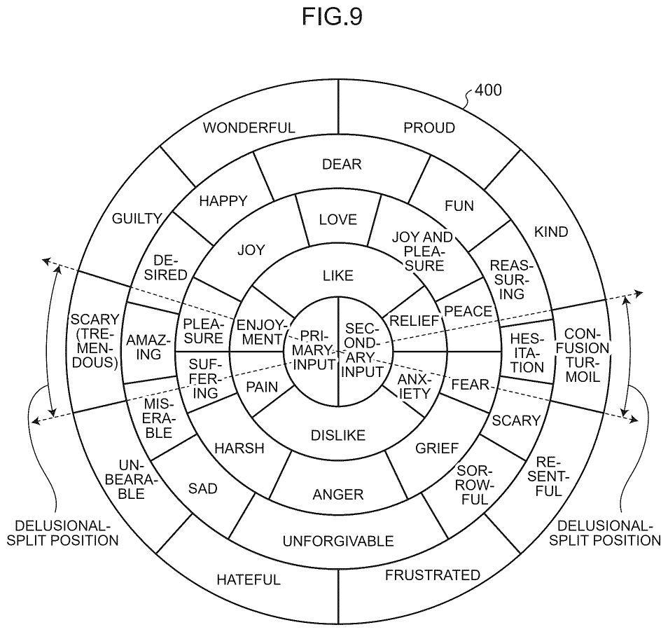

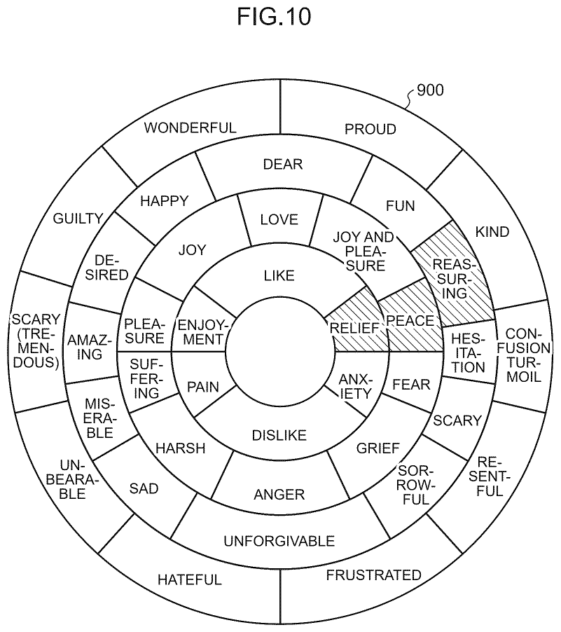

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used. Additionally, the examples described above were explained by dividing into form example 1 and form example 2, but these may be combined.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

### Additional Note 1

A system comprising: a reception unit configured to input a system configuration diagram; an analysis unit configured to analyze requirements based on the system configuration diagram input by the reception unit; and a generation unit configured to generate a design document and code based on the requirements analyzed by the analysis unit.

Additional Note 2 The system according to Additional Note 1, further comprising a dialog unit configured to interact regarding detailed contents of the requirements.

Additional Note 3 The system according to Additional Note 1, wherein the analysis unit is configured to analyze the requirements based on the system configuration diagram input by the reception unit and the dialog results from the dialog unit.

Additional Note 4 The system according to Additional Note 1, wherein the generation unit is configured to generate the design document and code by means of a generative AI.

Additional Note 5 The system according to Additional Note 1, wherein the generation unit supports multi-cloud, reads the type of cloud from the system configuration diagram, and selects an appropriate format.

Additional Note 6 The system according to Additional Note 1, wherein the generation unit is configured to generate Terraform code.

Additional Note 7 The system according to Additional Note 1, wherein the reception unit is configured to estimate a user's emotion and adjust the timing of inputting the system configuration diagram based on the estimated user's emotion.

Additional Note 8 The system according to Additional Note 1, wherein the reception unit is configured to analyze the user's past project history at the time of inputting the system configuration diagram and select an optimal input method.

Additional Note 9 The system according to Additional Note 1, wherein the reception unit is configured to perform filtering based on the user's current project status and areas of interest at the time of inputting the system configuration diagram.

Additional Note 10 The system according to Additional Note 1, wherein the reception unit is configured to estimate a user's emotion and determine the priority of system configuration diagrams to be input based on the estimated user's emotion.

Additional Note 11 The system according to Additional Note 1, wherein the reception unit is configured to prioritize inputting highly relevant configuration diagrams by considering the user's geographic location at the time of inputting the system configuration diagram.

Additional Note 12 The system according to Additional Note 1, wherein the reception unit is configured to analyze the user's social media activity at the time of inputting the system configuration diagram and input relevant configuration diagrams.

Additional Note 13 The system according to Additional Note 1, wherein the analysis unit is configured to estimate a user's emotion and adjust the method of requirements analysis based on the estimated user's emotion.

Additional Note 14 The system according to Additional Note 1, wherein the analysis unit is configured to adjust the level of detail of analysis based on the importance of the system configuration diagram during requirements analysis.

Additional Note 15 The system according to Additional Note 1, wherein the analysis unit is configured to apply different analysis algorithms according to the category of the system configuration diagram during requirements analysis.

Additional Note 16 The system according to Additional Note 1, wherein the analysis unit is configured to estimate a user's emotion and determine the priority of requirements analysis based on the estimated user's emotion.

Additional Note 17 The system according to Additional Note 1, wherein the analysis unit is configured to determine the priority of analysis based on the submission timing of the system configuration diagram during requirements analysis.

Additional Note 18 The system according to Additional Note 1, wherein the analysis unit is configured to adjust the order of analysis based on the relevance of the system configuration diagram during requirements analysis.

Additional Note 19 The system according to Additional Note 1, wherein the generation unit is configured to estimate a user's emotion and adjust the method of generating the design document and code based on the estimated user's emotion.

Additional Note 20 The system according to Additional Note 1, wherein the generation unit is configured to adjust the level of detail of generation based on the importance of the requirements when generating the design document and code.

Additional Note 21 The system according to Additional Note 1, wherein the generation unit is configured to apply different generation algorithms according to the category of the requirements when generating the design document and code.

Additional Note 22 The system according to Additional Note 1, wherein the generation unit is configured to estimate a user's emotion and adjust the order of generating the design document and code based on the estimated user's emotion.

Additional Note 23 The system according to Additional Note 1, wherein the generation unit is configured to determine the priority of generation based on the submission timing of the requirements when generating the design document and code.

Additional Note 24 The system according to Additional Note 1, wherein the generation unit is configured to adjust the order of generation based on the relevance of the requirements when generating the design document and code.

Additional Note 25 The system according to Additional Note 2, wherein the dialog unit is configured to estimate a user's emotion and adjust the progress of the dialog based on the estimated user's emotion.

Additional Note 26 The system according to Additional Note 2, wherein the dialog unit is configured to select an optimal dialog method by referring to the user's past dialog history during dialog.

Additional Note 27 The system according to Additional Note 2, wherein the dialog unit is configured to customize the content of the dialog based on the user's current project status during dialog.

Additional Note 28 The system according to Additional Note 2, wherein the dialog unit is configured to estimate a user's emotion and determine the priority of dialog based on the estimated user's emotion.

Additional Note 29 The system according to Additional Note 2, wherein the dialog unit is configured to select an optimal dialog method by considering the user's geographic location during dialog.

Additional Note 30 The system according to Additional Note 2, wherein the dialog unit is configured to analyze the user's social media activity during dialog and adjust the content of the dialog.

What is claimed is:

1. A system comprising: a reception unit configured to input a system configuration diagram; an analysis unit configured to analyze requirements based on the system configuration diagram input by the reception unit; and a generation unit configured to generate a design document and code based on the requirements analyzed by the analysis unit.

2. The system according to claim 1, further comprising a dialog unit configured to interact regarding detailed contents of the requirements.

3. The system according to claim 2, wherein the analysis unit is configured to analyze the requirements based on the system configuration diagram input by the reception unit and the dialog results from the dialog unit.

4. The system according to claim 1, wherein the generation unit is configured to generate the design document and code by means of a generative AI.

5. The system according to claim 1, wherein the generation unit supports multi-cloud, reads the type of cloud from the system configuration diagram, and selects an appropriate format.

6. The system according to claim 1, wherein the generation unit is configured to generate Terraform code.

7. The system according to claim 1, wherein the reception unit is configured to estimate a user's emotion and adjust the timing of inputting the system configuration diagram based on the estimated user's emotion.

8. The system according to claim 1, wherein the reception unit is configured to analyze the user's past project history at the time of inputting the system configuration diagram and select an optimal input method.

9. The system according to claim 1, wherein the reception unit is configured to perform filtering based on the user's current project status and areas of interest at the time of inputting the system configuration diagram.
